(19) United States
(12) Patent Application Publication
(10) Pub. No.: US 2022/0215359 A1
(43) Pub. Date: Jul. 7, 2022

(54) SETTLEMENT SERVER AND METHOD THEREOF

(71) Applicant: HAREXINFOTECH INC., Seoul (KR)

(72) Inventor: Kyung Yang PARK, Seoul (KR)

(73) Assignee: HAREXINFOTECH INC., Seoul (KR)

(21) Appl. No.: 17/607,704

(22) PCT Filed: Apr. 29, 2020
(86) PCT No.: PCT/KR2020/005758

§ 371 Date: Oct. 29, 2021

(30) Foreign Application Priority Data
Apr. 30, 2019 (KR) 10-2019-0050391

(51) Int. Cl. G06Q 20/10; G06Q 20/16

(52) U.S. Cl. CPC G06Q 20/102; G06Q 20/16

(57) ABSTRACT

Provided are a settlement server and methods for performing member store payment settlement and account management. The settlement server includes a receiver configured to receive deposit information and payment information to be sent to a service provider account according to payment approval, a memory in which a program for performing member store payment settlement using the deposit information and payment information is stored, and a processor configured to execute the program in which the processor performs balance adjustment between service provider accounts for each bank.

### TECHNICAL FIELD

The present invention relates to a settlement server and method thereof for performing member store payment settlement and account management.

### BACKGROUND ART

A transfer structure of a zero-pay model according to the related art allows a simple payment service provider to request a transfer to each bank through the Korea Financial Telecommunications & Clearings Institute (KFTC) network on behalf of a customer.

The transfer structure is a structure in which the transfer is made from a customer bank account to a simple payment service provider account through the KFTC network (common financial network), and the transfer is made from the simple payment service provider account to an affiliate store main account through the KFTC network, and a hub system performs a settlement and transfer process.

However, the related art has a problem of causing a transfer fee by using the KFTC network.

### DISCLOSURE

### Technical Problem

The present invention is directed to providing a server and a method thereof capable of automating member store payment settlement by proposing a fee-free shared model transfer structure according to a intra bank transfer method that does not involve transfer costs.

### Technical Solution

One aspect of the present invention provides a settlement server according to the present invention including: a receiver configured to receive deposit information and payment information to be sent to a service provider account according to payment approval; a memory in which a program for performing member store payment settlement using the deposit information and payment information is stored; and a processor configured to execute the program, in which the processor performs balance adjustment between service provider accounts for each bank.

Another aspect of the present invention provides a settlement method including: (a) confirming amount information deposited into a service provider account according to payment approval; calculating member store settlement amount using the amount information and transaction information matched thereto, and calculating a total amount to be adjusted for each service provider account; adjusting a balance between service provider accounts according to the total amount to be adjusted; and transferring payment to an affiliate store account.

### Advantageous Effects

According to the present invention, a intra bank transfer (transaction amount deposit) is made from a payment customer bank account or a card company to a service provider account of the intra bank, a intra bank transfer is made from the service provider account of an affiliate store main bank to an affiliate store main account, and a balance adjustment between the service provider accounts of each bank is performed, and thus there is an effect that transfer fee related costs are not incurred.

The effects of the present invention are not limited to those described above, and other effects not described can be clearly understood by those skilled in the art from the following description.

### DESCRIPTION OF DRAWINGS

FIG. 1 is a block diagram illustrating a payment settlement server (service provider server) according to an embodiment of the present invention.

FIG. 2 is a diagram illustrating a process of completing transaction approval and transferring a payment amount according to an embodiment (debit payment) of the present invention.

FIG. 3 is a diagram illustrating an approval amount, a fee, and settlement data according to an embodiment of the present invention.

FIG. 4 is a diagram illustrating an affiliate store-based planned deposit amount according to an embodiment of the present invention.

FIG. 5 is a diagram illustrating a bank-based planned deposit amount according to an embodiment of the present invention.

FIG. 6 is a diagram illustrating a result of calculating payment account settlement data and an account balance adjustment amount for each bank according to an embodiment of the present invention.

FIG. 7 is a diagram illustrating a process of determining a deposit/withdrawal target service provider account and an adjustment amount according to an embodiment of the present invention.

FIG. 8 is a diagram illustrating a balance adjustment process between service provider accounts according to an embodiment of the present invention.

FIG. 9 is a diagram illustrating a process of transferring member store payment to each service provider account according to an embodiment of the present invention.

FIG. 10 is a diagram illustrating a result of verifying an actual balance of a service provider account and a system database (DB) balance according to an embodiment of the present invention.

FIGS. 11A and 11B are diagrams illustrating a process of adjusting a balance between service provider accounts according to another embodiment of the present invention.

FIG. 12 is a diagram illustrating settlement data according to another embodiment (credit card payment) of the present invention.

FIG. 13 is a diagram illustrating an affiliate store-based planned deposit amount according to another embodiment of the present invention.

FIG. 14 is a diagram illustrating a bank-based planned member store deposit amount according to another embodiment of the present invention.

FIG. 15 is a diagram illustrating a result of calculating payment account settlement data and an account balance adjustment amount for each bank according to another embodiment of the present invention.

FIG. 16 is a diagram illustrating a process of determining a deposit/withdrawal target service provider account and an adjustment amount according to another embodiment of the present invention.

FIG. 17 illustrates a process of depositing payment into a service provider account according to another embodiment of the present invention.

FIG. 18 is a diagram illustrating a process of adjusting a balance between service provider accounts according to another embodiment of the present invention.

FIG. 19 is a diagram illustrating a process of transferring member store payment to each service provider account according to another embodiment of the present invention.

FIG. 20 is a diagram illustrating a result of verifying an actual balance of a service provider account and a system DB balance according to another embodiment of the present invention.

FIG. 21 is a flowchart illustrating a settlement method according to an embodiment of the present invention.

### MODES OF THE INVENTION

The above-described aspect, and other aspects, advantages, and features of the present invention and methods accomplishing them will become apparent from the following detailed description of exemplary embodiments with reference to the accompanying drawings.

However, the present invention may be modified in many different forms, and it should not be limited to the exemplary embodiments set forth herein. Only the following embodiments are provided to easily inform those of ordinary skill in the art to which the present invention pertains of the objects, configurations, and effects of the invention, and the scope of the present invention is defined by the description of the claims.

Meanwhile, terms used in the present specification are for explaining exemplary embodiments rather than limiting the present invention. In the present invention, a singular form includes a plural form unless explicitly described to the contrary. Components, steps, operations, and/or elements described by terms “comprise” and/or “comprising” used in the present invention do not exclude the existence or addition of one or more other components, steps, operations, and/or elements.

The present invention proposes a settlement server and method for performing member store payment settlement by introducing a intra bank transfer method that does not involve transfer costs due to absence of an intermediary.

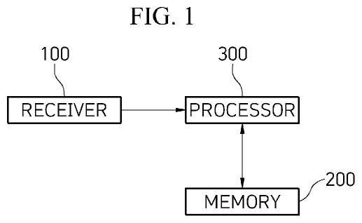

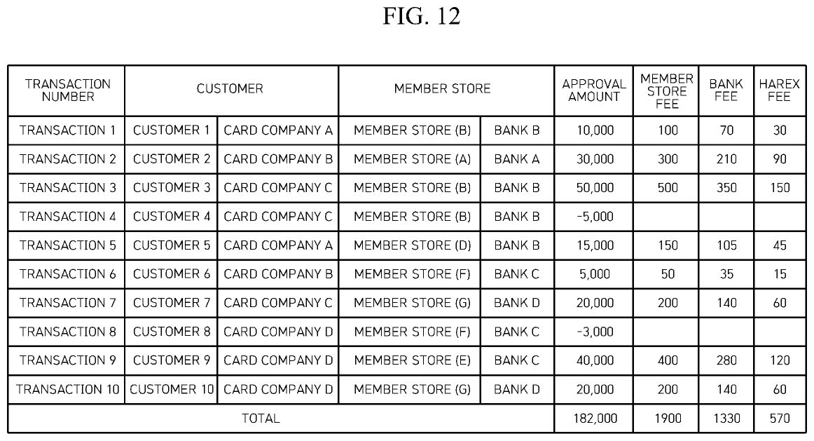

Hereinafter, an embodiment (debit payment) of the present invention will be described in detail with reference to FIGS. 1 to 11B, and another embodiment (credit card payment) of the present invention will be described in detail with reference to FIGS. 12 to 20.

After payment according to an embodiment of the present invention, an automated payment settlement system for maintaining a balance of a payment holding account and stabilizing payment until member store settlement and payment will be described.

FIG. 1 is a block diagram illustrating a payment settlement system according to an embodiment of the present invention.

According to the present invention, a settlement server includes a receiver 100 configured to receive deposit information and payment information to be sent to a service provider account according to payment approval, a memory 200 in which a program for performing member store payment settlement using the deposit information and the payment information is stored, and a processor 300 configured to execute the program in which the processor 300 performs balance adjustment between service provider accounts for each bank.

The processor 300 generates settlement data using payment information including customer information, member store information, an approval amount, and fee information, but uses the customer information that includes customer's account information used when making debit payment and a customer's credit card company information used when making credit payment, and uses the member store information that includes member store unique information and member store account information.

The processor 300 generates settlement data using the fee information that includes an affiliate store fee, a bank or a card company fee, and a service provider fee.

The processor 300 calculates settlement data for each service provider account provided in each bank, calculates a total amount to be adjusted for each account, and makes a transfer from a first service provider account with a surplus amount to a second service provider account with an insufficient amount in consideration of the total amount to be adjusted to thereby perform balance adjustment.

In this case, according to an embodiment, the processor 300 may make a transfer from service provider accounts which have a surplus amount in order of the largest absolute value of the total amount to be adjusted to service provider accounts, which have an insufficient amount in the order of the largest absolute value of the total amount to be adjusted, according to a preset order and sequentially adjust a balance in consideration of balance information after the transfer.

According to another embodiment, the processor 300 may adjust the balance according to the preset method so that the total number of steps of the transfer process (balancing process) is minimized in consideration of the information on the service provider account with a surplus amount of the total amount to be adjusted and the service provider account with an insufficient amount of the total amount to be adjusted.

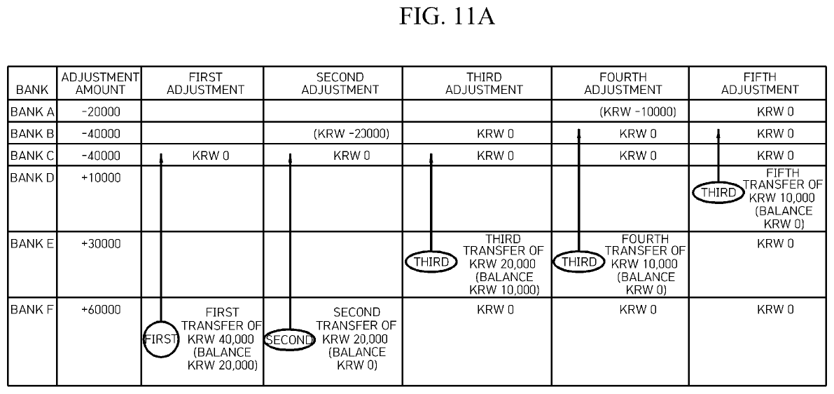

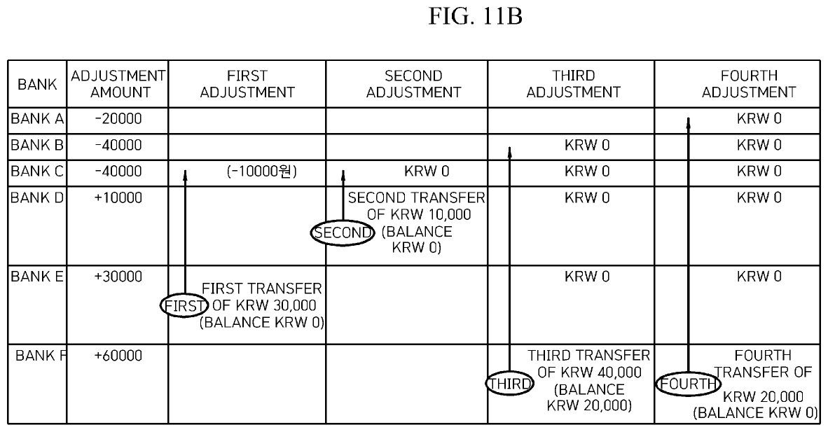

This will be described below in the detailed description with reference to FIGS. 11A and 11B.

When the balance adjustment is completed, the processor 300 requests an affiliate store settlement amount transfer and compares and verifies the balance of the service provider accounts for each bank and data on a database to perform a settlement completion process.

First, prior to describing the case of debit payment according to an embodiment of the present invention, preconditions will be described first to aid in understanding of those skilled in the art.

Precondition

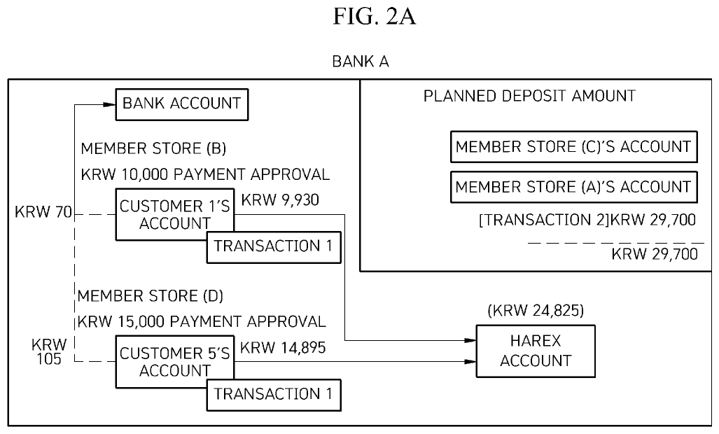

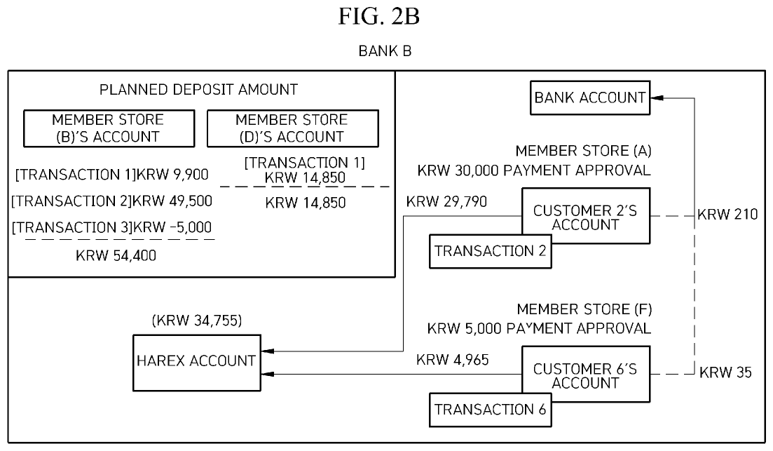

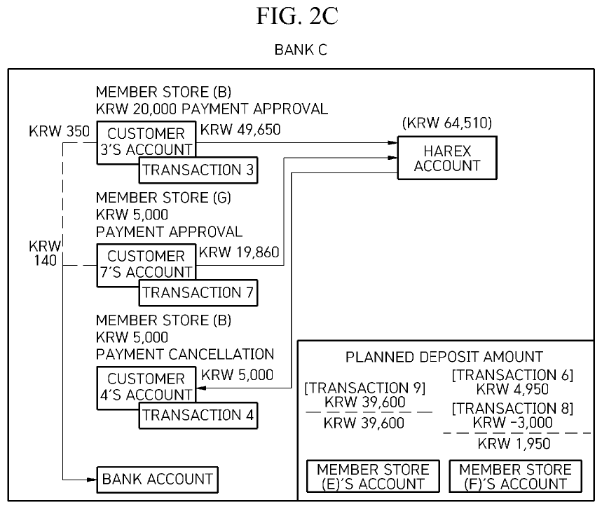

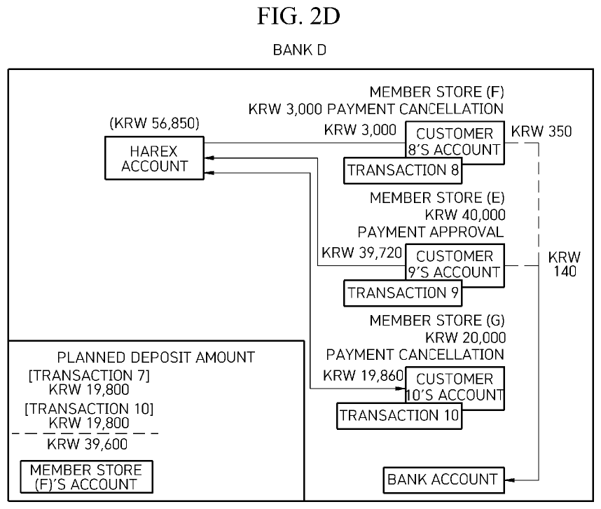

Referring to FIG. 2, a bank A account is registered as a payment method in a service application installed on terminals owned by customer 1 and customer 5.

A bank B account is registered as a payment method in service applications of customer 2 and customer 6.

A bank C account is registered as a payment method in service applications of customer 3, customer 4, and customer 7.

A bank D account is registered as a payment method in service applications of customer 8, customer 9, and customer 10.

Banks A, B, C, and D all have settlement amount dedicated accounts of service providers.

Banks A, B, C, and D all have settlement amount deposit accounts of member stores.

Member store accounts of member store (A) and member store (C) are bank A accounts.

Member store accounts of member store (B) and member store (D) are bank B accounts.

Member store accounts of member store (E) and member store (F) are bank C accounts.

An affiliate store account of member store (G) is a bank D account.

A service application member store settlement cycle is D+1 day, and a fee rate is 1.0% of a payment amount, in which, in the fee rate, 0.7% is accepted by the bank and 0.3% is accepted by a service provider.

There is no separate transfer fee for a transfer in the intra bank.

Hereinafter, a transaction approval request, a transaction approval completion, a payment amount transfer, an approval result transfer, and a settlement processing process of a service provider server (settlement server) will be described.

Transaction Approval Request

Referring to FIG. 2, (transaction 1) customer 1 requests payment approval for KRW 10,000 in bank A account from member store (B).

(Transaction 2) Customer 2 requests payment approval for KRW 30,000 in a bank B account from member store (A).

(Transaction 3) Customer 3 requests payment approval for KRW 50,000 in a bank C account from member store (B).

(Transaction 4) Customer 4 requests cancellation approval for KRW 5,000 from member store (B).

(Transaction 5) Customer 5 requests payment approval for KRW 15,000 in a bank A account from member store (D).

(Transaction 6) Customer 6 requests payment approval for KRW 5,000 in a bank B's account from member store (F).

(Transaction 7) Customer 7 requests payment approval for KRW 20,000 in a bank C account from member store (G).

(Transaction 8) Customer 8 requests cancellation approval for KRW 3,000 from member store (F).

(Transaction 9) Customer 9 requests payment approval for KRW 40,000 in a bank D's account from member store (E).

(Transaction 10) Customer 10 requests payment approval for KRW 20,000 in a bank D account from member store (G).

Hereinafter, a process of completing transaction approval and transferring a payment amount will be described with reference to FIG. 2.

Transaction Approval Completion and Payment Amount Transfer

(Transaction 1) KRW 10,000 is withdrawn from a customer 1's account in bank A, in which, of KRW 10,000, KRW 9,930 is transferred to a service provider account in bank A, excluding a bank fee of KRW 70.

(Transaction 2) KRW 30,000 is withdrawn from a customer 2's account in bank B, in which, of KRW 30,000, KRW 29,790 is transferred to a service provider account in bank B, excluding a bank fee of KRW 210.

(Transaction 3) KRW 50,000 is withdrawn from a customer 3's account in bank C, in which, of KRW 50,000, KRW 49,650 is transferred to a service provider account in bank C, excluding a bank fee of KRW 350.

(Transaction 4) A cancellation amount of KRW 5,000 is transferred from the service provider account in bank C to a customer 4's account in bank C.

(Transaction 5) KRW 15,000 is withdrawn from a customer 5's account in bank A, in which, of KRW 15,000, KRW 14,895 is transferred to a service provider account in bank A, excluding a bank fee of KRW 105.

(Transaction 6) KRW 5,000 is withdrawn from a customer 6's account in bank B, in which, of KRW 5,000, KRW 4,965 is transferred to a service provider account in bank B, excluding a bank fee of KRW 35.

(Transaction 7) KRW 20,000 is withdrawn from a customer 7's account in bank C, in which, of KRW 20,000, KRW 19,860 is transferred to a service provider account in bank C, excluding a bank fee of KRW 140.

(Transaction 8) A cancellation amount of KRW 3,000 is transferred from a service provider account in bank D to a customer 8's account in bank D.

(Transaction 9) KRW 40,000 is withdrawn from a customer 9's account in bank D, in which, of KRW 40,000, KRW 39,720 is transferred to a service provider account in bank D, excluding a bank fee of KRW 280.

(Transaction 10) KRW 20,000 is withdrawn from a customer 10's account in bank D, in which, of KRW 20,000, KRW 19,860 is transferred to a service provider account in bank D, excluding a bank fee of KRW 140.

The approval result for the above-described transaction approval request is displayed through a service application installed on a customer's terminal, and the contents of the approval result are displayed on terminals (point-of-sale (POS), App/Web) of all member stores that have completed the transaction.

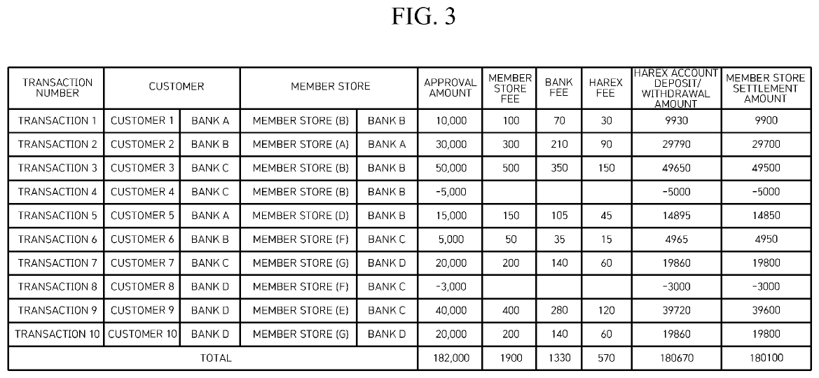

Hereinafter, the settlement processing process in the service provider server will be described with reference to FIGS. 3 to 5.

Service Provider Server Settlement Processing

The service provider server calculates settlement data necessary for each transaction based on the approval result data and stores the calculated settlement data in the database in real time.

Referring to FIG. 3, the service provider server stores data such as a transaction serial number for each transaction, customer identification information, payment bank information, member store information, member store account bank information, approval amount, an affiliate store fee, a bank fee, a service provider fee, deposit/withdrawal amount of a service provider account, and member store settlement amount information.

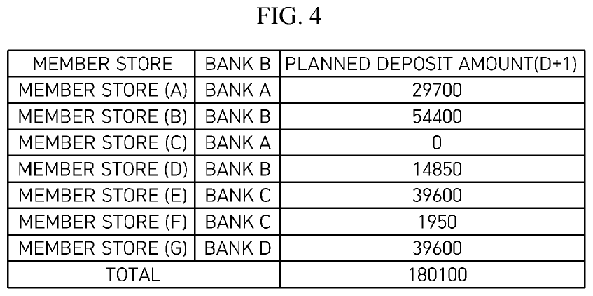

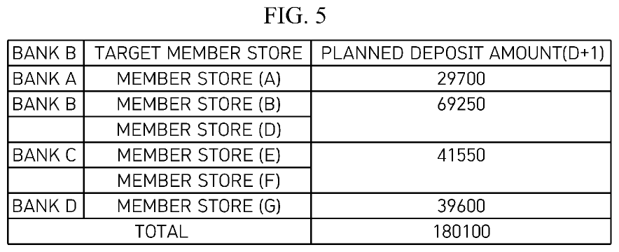

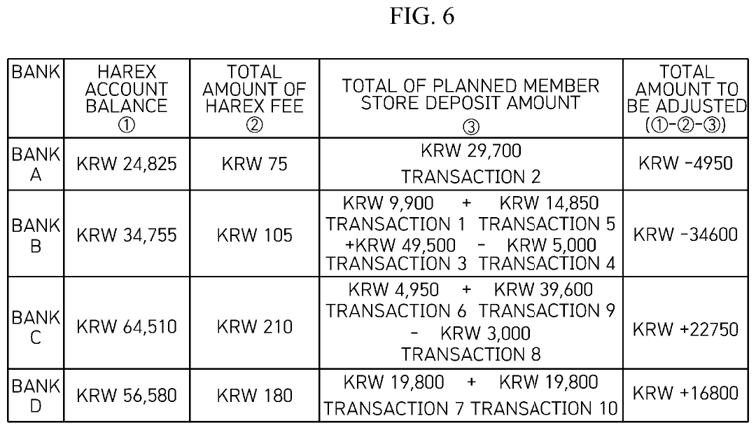

FIG. 4 illustrates an affiliate store-based planned deposit amount according to an embodiment of the present invention, and FIG. 5 illustrates a bank-based member store planned deposit amount according to an embodiment of the present invention. Referring to FIGS. 6 and 7, a service provider server aggregates and stores the settlement data stored in the database for each item.

In this case, information on a total amount to be adjusted for each service provider account is calculated based on a total of a service provider account deposit amount, a total amount of a service provider fee, and a total of a settlement amount for each member store account bank by collecting all of previous day's approval results and approval cancellation results, and calculated information is stored in a database.

For example, according to the above-described preconditions, the total amount to be adjusted for the service provider account in bank A is KRW −4,950, the total amount to be adjusted for the service provider account in bank B is KRW −34,600, the total amount to be adjusted for the service provider account in bank C is KRW +22,750, and the total amount to be adjusted for the service provider account in bank D is KRW +16,800.

FIG. 7 is a diagram illustrating a process of determining a deposit/withdrawal target service provider account and an adjustment amount according to an embodiment of the present invention.

A transfer from service provider accounts, which have a surplus amount in order of the largest absolute value of the total amount to be adjusted to service provider accounts, which have an insufficient amount in the order of the largest absolute value of the total amount to be adjusted, is made according to a preset order, and a balance is sequentially adjusted in consideration of balance information after the transfer.

Referring to FIG. 7, a transfer is made from the service provider account in bank C with the largest total amount to be adjusted to the service provider account in bank B (first adjustment), a transfer is made from the service provider account in bank D to the service provider account in bank B in which a balance to be adjusted is present (second adjustment), and a transfer is made from the service provider account in bank D to the service provider account in bank A in which a balance to be adjusted is present (third adjustment).

The service provider server compares and verifies whether there are any abnormalities through aggregate data and bank deposit/withdrawal data for each bank account or data (scraping or electronic file) for reconciliation processing provided by a bank, and when an error occurs after automatic reconciliation processing, automatically provides information on the error case.

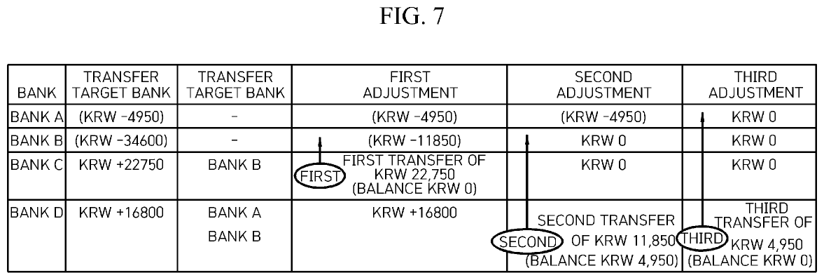

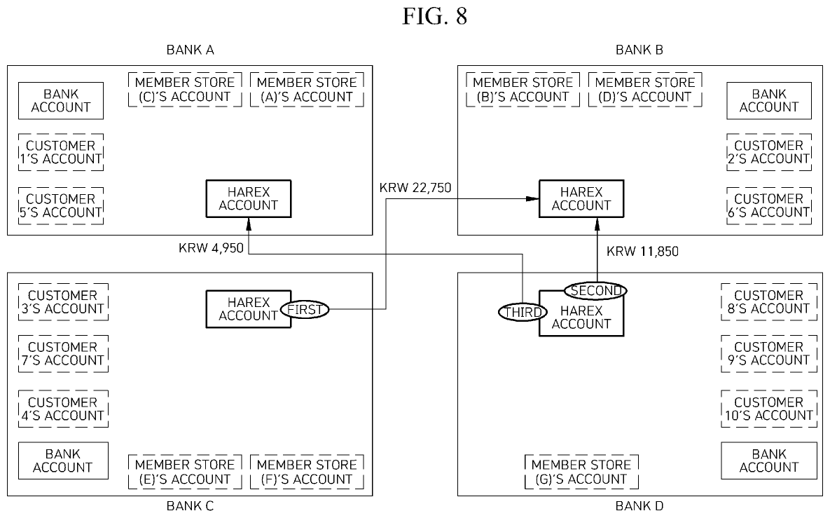

Referring to FIG. 8, the service provider server automatically manages the balances of the service provider servers for each bank from the aggregate completion to the deposit of the member store settlement amount on the same day.

In this case, a transfer is made from a service provider account with a surplus amount to a service provider account with an insufficient amount according to the total of member store settlement amount for each service provider account to thereby adjust the balance between the service provider accounts.

The service provider server processes aggregate data including cancellation cases on the same day during the set settlement business hours and performs automatic reconciliation processing for each member store and bank and verifies the presence or absence of abnormal data in the settlement details.

In this case, when an abnormality or confirmation request item is found during the reconciliation operation, a notification (short message service (SMS), e-mail, etc.) is sent to a person in charge of settlement and a relevant person.

In this case, until the confirmation and processing are completed in the system by the person in charge of settlement and the relevant person, a planned payment amount of a bank to a targeted member store is converted to temporary payment pending and is temporarily stored in the database.

Examples of the abnormal state may include a case where a settlement amount of a specific member store has significantly increased in the last few months or compared to the previous year, a case where a specific transaction amount in a specific member store is excessively high compared to the existing transactions or a customer transaction[u1], a case where a settlement amount of a new member store scheduled for first settlement is more than a specific amount, a case where an affiliate store account is changed more than a specific number of times, a case where an affiliate store in which transaction approval and approval cancellation for the same transaction repeatedly occur in large numbers, and the like.

In this case, as a preset for the example of the abnormal state, when preference for a specific product (e.g., shaved ice specialty store, etc.) is high by season, it is possible to determine the settlement details as an exception of the abnormal state, that is, as a normal state.

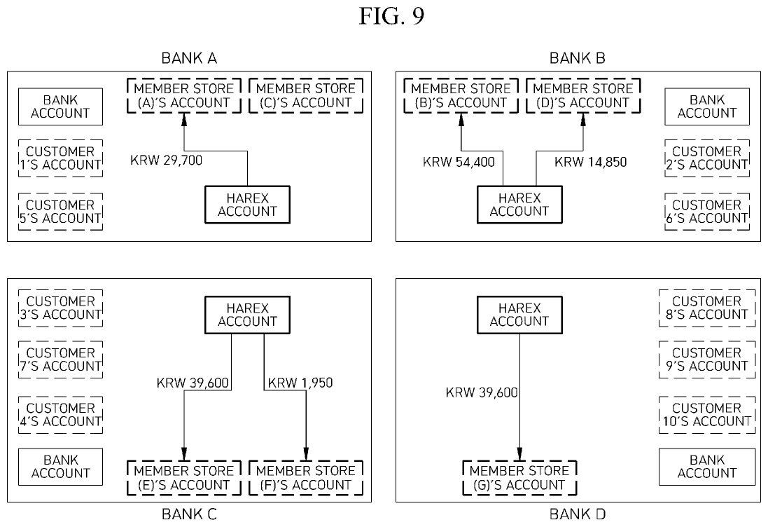

Referring to FIG. 9, the service provider server requests an affiliate store settlement amount transfer from each bank server.

KRW 29,700 is transferred from the service provider account in bank A to bank A account of member store (A), KRW 54,400 is transferred from the service provider account in bank B to bank B account of member store (B), KRW 14,850 is transferred from the service provider account in bank B to bank B account of member store (D), KRW 39,600 is transferred from the service provider account in bank C to bank C account of member store (E), KRW 1,950 is transferred from the service provider account in bank C to bank C account of member store (F), and KRW 39,600 is transferred from the service provider account in bank D to bank D account of member store (G).

In this case, the bank server transfers member store payment to each member store, and an affiliate store with the payment pending may confirm the information on pending details on a manager screen, and a normal transfer and payment are completed after confirmation by a relevant internal person.

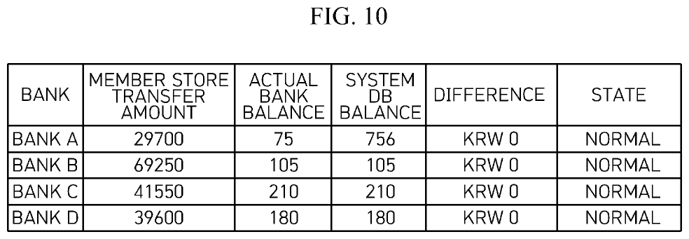

Referring to FIG. 10, the service provider server compares and verifies balances of service provider accounts for each bank with data on the database and then completes settlement of each member store settlement amount.

The service provider server requests the bank server to transfer service provider fees for each bank from service provider accounts to fee accounts (settlement completion fee, KRW 75 for bank A, KRW 105 for bank B, KRW 210 for bank C, and KRW 180 for bank D).

In this case, the fee accounts are opened for each bank and managed separately.

According to an embodiment of the present invention, when a payment cancellation request occurs, approval is processed only when a cancellation amount is less than or equal to a planned deposit amount to the corresponding member store, and an amount obtained by deducting the canceled amount from the total of member store settlement amount is paid.

FIGS. 11A and 11B are diagrams illustrating a process of adjusting a balance between service provider accounts according to an embodiment of the present invention.

As illustrated in FIGS. 11A and 11B, assume that a total amount to be adjusted for service provider accounts of bank A, bank B, and bank C is KRW −20,000, KRW −20,000, and KRW −40,000, respectively, and a total amount to be adjusted for service provider accounts of bank D, bank E, and bank F is KRW +10,000, KRW +30,000, and KRW +60,000, respectively.

FIG. 11A is a diagram according to the above-described embodiment, in which a transfer is made from the service provider account in bank F with the largest total amount to be adjusted to the service provider account in bank C (first adjustment), a transfer is made from the service provider account in bank F to the service provider account in bank B (second adjustment), a transfer is made from the service provider account in bank E to the service provider account in bank B in which a balance to be adjusted is present (third adjustment), a transfer is made from the service provider account in bank E to the service provider account in bank A (fourth adjustment), and a transfer is made from the service provider account in bank D to the service provider account in bank A in which a balance to be adjusted is present (fifth adjustment).

This is based on the fact that a transfer from service provider accounts, which have a surplus amount in order of the largest absolute value of the total amount to be adjusted to service provider accounts, which have an insufficient amount in the order of the largest absolute value of the total amount to be adjusted, is made according to a preset order, and a balance is sequentially adjusted in consideration of balance information after the transfer.

As another embodiment, referring to FIG. 11B, the processor 300 may adjust the balance according to the preset method so that the total number of steps of the transfer process (balancing process) is minimized in consideration of the information on the service provider account with a surplus amount of the total amount to be adjusted and the service provider account with an insufficient amount of the total amount to be adjusted.

Referring to FIG. 11B, the processor 300 makes a transfer from the service provider account in bank E to the service provider account in bank C (first adjustment), makes a transfer from the service provider account in bank D to the service provider account in bank C in which the balance to be adjusted is present (second adjustment), makes a transfer from the service provider account of Bank F to the service provider account in bank B (third adjustment), and makes a transfer from the service provider account in bank F to the service provider account in bank A (fourth adjustment).

That is, according to the embodiment of the present invention, a balance between accounts is performed by transferring from the service provider account in which the total amount to be adjusted remains to the service provider account in which the total amount to be adjusted is insufficient, but it is possible to make a transfer in consideration of the absolute value of the total amount to be adjusted, or it is possible to perform the balancing by controlling the adjustment process to be performed efficiently.

Hereinafter, a case of payment using a credit card according to another embodiment of the present invention will be described, and preconditions will be first described to help understand those skilled in the art.

Precondition

Card A is registered as a payment method in service applications installed on the terminals of customer 1 and customer 5.

Card B is registered as a payment method in service applications of customer 2 and customer 6.

Card C is registered as a payment method in service applications of customer 3, customer 4, and customer 7.

Card D is registered as a payment method in service applications of customer 8, customer 9, and customer 10.

Banks A, B, C, and D all have settlement amount dedicated accounts of service providers.

Banks A, B, C, and D all have settlement amount deposit accounts of member stores.

Service providers are registered as representative member stores in card companies A, B, C, and D.

The card company A deposits member store payment into a service provider account of the bank A (fee 2.0%, settlement cycle D+2 days).

The card company B deposits member store payment into a service provider account of the bank B (fee 2.0%, settlement cycle D+3 days).

The card company C deposits member store payment into a service provider account of the bank C (fee 2.0%, settlement cycle D+4 days).

The card company D deposits member store payment into a service provider account of the bank D (fee 2.0%, settlement cycle D+2 days).

In this case, a fee system is different depending on a bank identification number (BIN) of the card company (credit/check/others).

Member stores (A), (B), (C), and (D) are sub-member stores of service providers.

Member store accounts of member store (A) and member store (C) are bank A accounts.

Member store accounts of member store (B) and member store (D) are bank B accounts.

Member store accounts of member store (E) and member store (F) are bank C accounts.

An affiliate store account of member store (G) is a bank D account.

A service application member store fee rate is 2.5% of a payment amount, and the settlement cycle is D+5 days.

For partial cancellation after approval of purchase, a cancellation fee is non-refundable, and there is no separate transfer fee for a transfer in the intra bank.

Hereinafter, transaction approval, settlement processing of a service provider server, and a transaction payment process will be described.

Transaction Approval Request

Referring to FIG. 12, (transaction 1) payment for KRW 10,000 at member store (B) of customer 1 of card company A is approved.

(Transaction 2) Payment for KRW 30,000 at member store (A) of customer 2 of card company B is approved.

(Transaction 3) Payment for KRW 50,000 at member store (B) of customer 3 of card company C is approved.

(Transaction 4) Payment cancellation for KRW 5,000 at member store (B) of customer 4 of card company C is approved.

(Transaction 5) Payment for KRW 15,000 at member store (D) of customer 5 of card company A is approved.

(Transaction 6) Payment for KRW 5,000 at member store (F) of customer 6 of card company B is approved.

(Transaction 7) Payment for KRW 20,000 at member store (G) of customer 7 of card company C is approved.

(Transaction 8) Payment cancellation for KRW 3,000 at member store (F) of customer 8 of card company D is approved.

(Transaction 9) Payment for KRW 40,000 at member store (E) of customer 9 of card company D is approved.

(Transaction 10) Payment for KRW 20,000 at member store (G) of customer 10 of card company D is approved.

Hereinafter, the settlement processing process in the settlement server (service provider server) will be described with reference to FIGS. 12 to 14.

Service Provider Server Settlement Processing

The service provider server generates purchase data based on the previous day's transaction ledger at a set purchase time and receives purchase approval requests/results for each card company.

The service provider server calculates settlement data necessary for each transaction based on the approval result data and stores the calculated settlement data in the database in real time.

Referring to FIG. 12, the service provider server stores data such as a transaction serial number for each transaction, customer information, card company information, member store information, member store account bank information, approval amount information, an affiliate store fee, a card company fee, a service provider fee, deposit/withdrawal amount of a service provider account (stored for each settlement cycle), and member store settlement amount information.

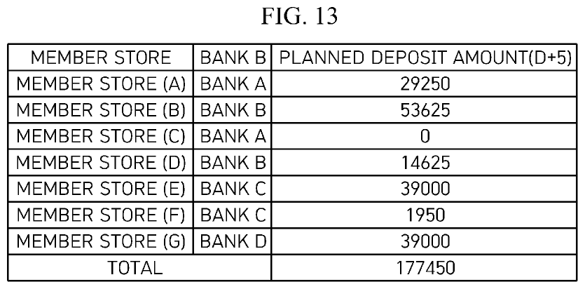

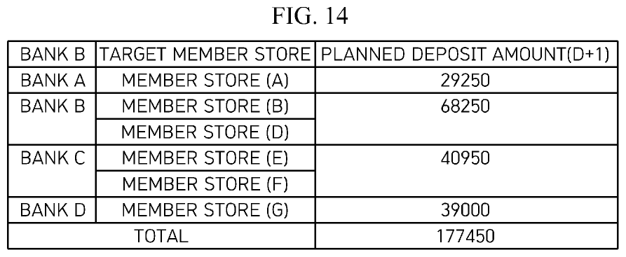

FIG. 13 illustrates an affiliate store-based planned deposit amount according to another embodiment of the present invention, and FIG. 14 illustrates a bank-based member store planned deposit amount according to another embodiment of the present invention.

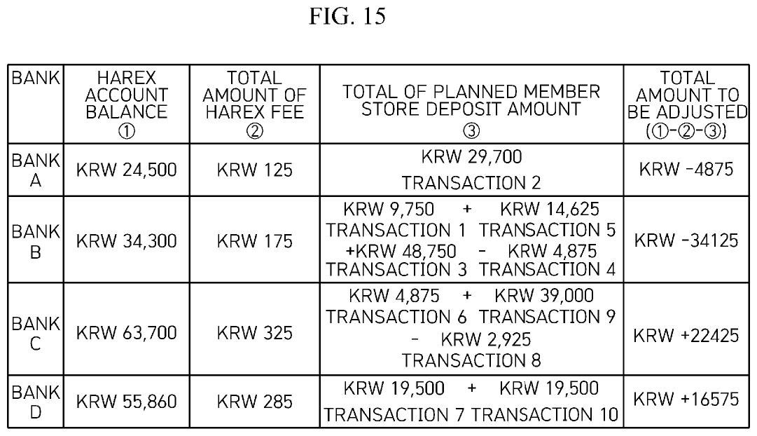

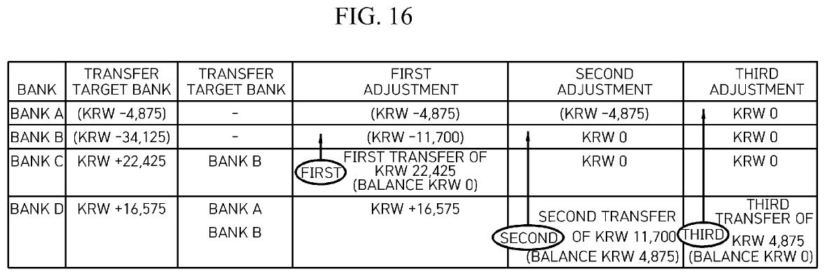

Referring to FIGS. 15 and 16, a service provider server aggregates and stores the settlement data stored in the database for each item.

In this case, information on a total amount to be adjusted for each service provider account is calculated based on a balance of a service provider account, a total amount of a service provider fee, and a total of a planned member store deposit amount by collecting all previous day's approval results and approval cancellation results, and calculated information is stored in a database.

For example, according to the above-described preconditions, the total amount to be adjusted for the service provider account in bank A is KRW −4,875, the total amount to be adjusted for the service provider account in bank B is KRW −34,125, the total amount to be adjusted for the service provider account in bank C is KRW +22,425, and the total amount to be adjusted for the service provider account in bank D is KRW +16,575.

FIG. 16 is a diagram illustrating a process of determining a deposit/withdrawal target service provider account and an adjustment amount according to another embodiment of the present invention.

In this case, a transfer is made from the service provider account in bank C with the largest total amount to be adjusted to the service provider account in bank B (first adjustment, KRW 22,425 transfer), a transfer is made from the service provider account in bank D to the service provider account in bank B in which a balance to be adjusted is present (second adjustment, KRW 11,700 transfer), and a transfer is made from the service provider account in bank D to the service provider account in bank A in which a balance to be adjusted is present (third adjustment, KRW 4,875 transfer).

That is, a transfer from service provider accounts, which have a surplus amount in order of the largest absolute value of the total amount to be adjusted to service provider accounts, which have an insufficient amount in the order of the largest absolute value of the total amount to be adjusted, is made according to a preset order, and a balance is sequentially adjusted in consideration of balance information after the transfer.

As another example, as described above with reference to FIG. 11B, it is also possible to perform balancing in consideration of the total number of steps so that the adjustment process can be efficiently performed.

When an abnormality or confirmation request is found after aggregation of settlement, a notification is sent to a person in charge of settlement and a relevant person by SMS, e-mail, or the like. In this case, until the confirmation and processing by the person in charge of settlement and the relevant person is completed in the system, a planned payment amount of a targeted member store and bank is converted to temporary payment pending and is temporarily stored in the database.

Examples of the abnormal state may include a case where a settlement amount of a specific member store has significantly increased in the last few months or compared to the previous year, a case where a specific transaction amount in a specific member store is excessively high compared to the existing transactions or a customer transaction, a case where settlement amount of a new member store scheduled for first settlement is more than a specific amount, a case where an affiliate store account is changed more than a specific number of times, a case where an affiliate store in which transaction approval and approval cancellation for the same transaction repeatedly occurs in large numbers, and the like.

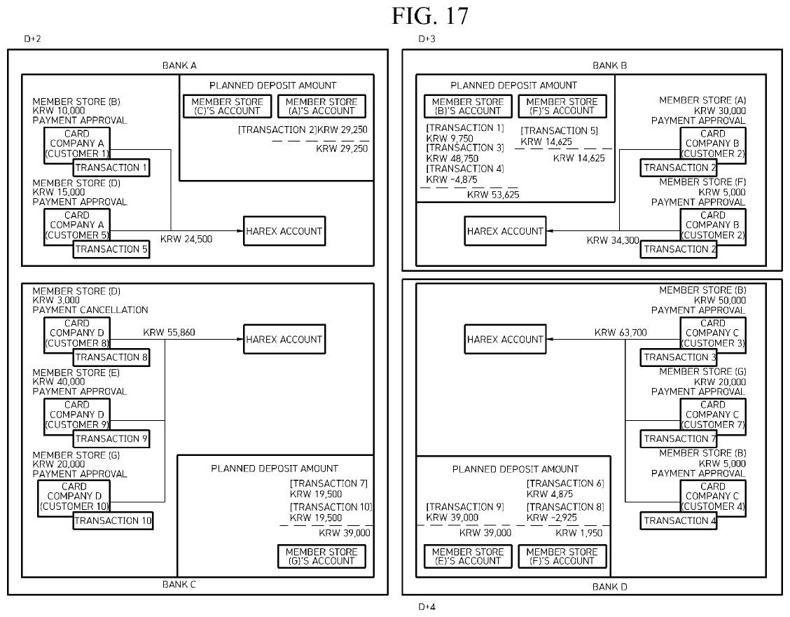

Hereinafter, a process of depositing a transaction amount from a card company to a service provider account will be described with reference to FIG. 17.

Transaction Amount Deposit (D+2)

(Transaction 1)+(Transaction 5) Card company A transfers KRW 24,500 to the service provider account in bank A, excluding KRW 500.

(Transaction 8)+(Transaction 9) Card company D transfers KRW 55,860 to the service provider account in bank D, excluding KRW 1,140.

Transaction Amount Deposit (D+3) (Transaction 2)+(Transaction 6) Card company B transfers KRW 34,300 to the service provider account in bank B, excluding KRW 700.

Transaction Amount Deposit (D+4)

(Transaction 3)+(Transaction 4)+(Transaction 7) Card company C transfers KRW 63,700 to the service provider account in bank C, excluding KRW 1,300.

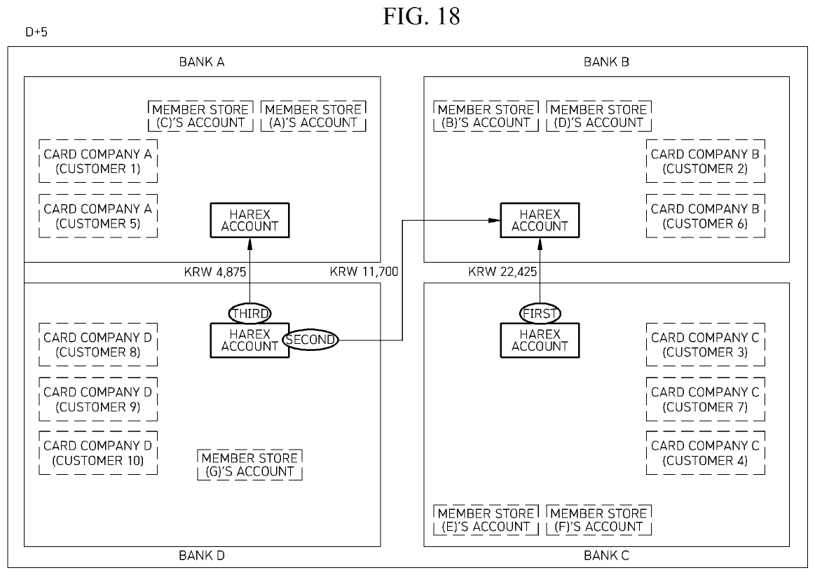

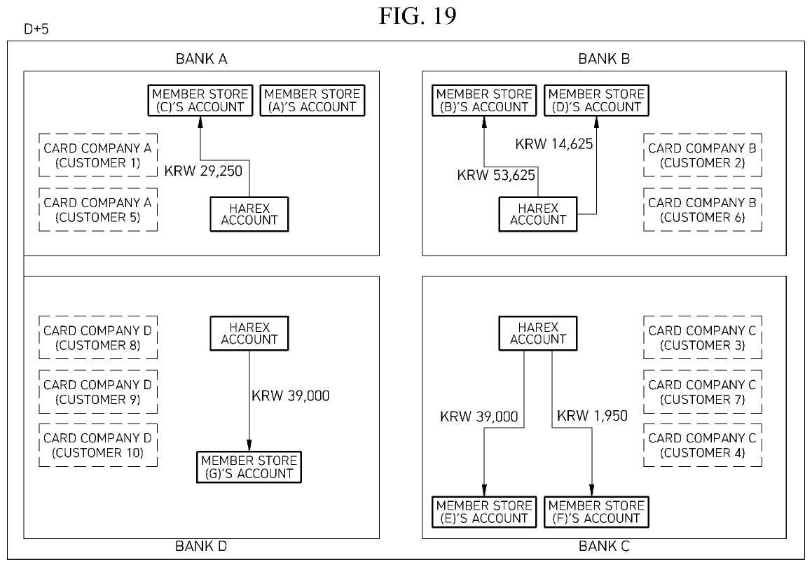

FIG. 18 shows a balance adjustment process between service provider accounts according to another embodiment of the present invention illustrated in FIG. 16. Referring to FIG. 19, member store payment is transferred from the service provider account to each member store account.

Member Store Payment Transfer

The service provider server compares and verifies whether there are any abnormalities in a deposit status through aggregate data and data (scraping or electronic file) for reconciliation processing that may confirm actual deposit state for each bank account or card company and, when an error occurs after automatic reconciliation processing, automatically provides information on the error case.

Referring to FIG. 18, the service provider server manages the balances of the service provider servers for each bank from the aggregate completion to the deposit of the member store settlement amount on the same day by an automatic management system.

In this case, a transfer is made from a service provider account with a surplus amount to a service provider account with an insufficient amount according to the total of member store settlement amount for each service provider account to thereby adjust the balance between the service provider accounts.

Referring to FIG. 19, the service provider server requests an affiliate store settlement amount transfer from each bank server.

KRW 29,250 is transferred from the service provider account in bank A to bank A account of member store (A), KRW 53,625 is transferred from the service provider account in bank B to bank B account of member store (B), KRW 14,625 is transferred from the service provider account in bank B to bank B account of member store (D), KRW 39,000 is transferred from the service provider account in bank C to bank C account of member store (E), KRW 1,950 is transferred from the service provider account in bank C to bank C account of member store (F), and KRW 39,000 is transferred from the service provider account in bank D to bank D account of member store (G).

In this case, the bank server transfers member store payment to each member store, and an affiliate store with the payment pending may confirm the information on pending details on a manager screen, and a normal transfer and payment are completed after confirmation by a relevant internal person.

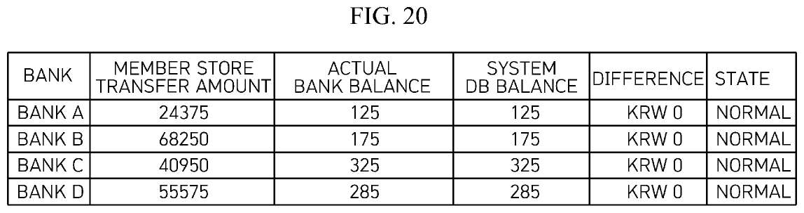

Referring to FIG. 20, the service provider server compares and verifies balances of service provider accounts for each bank with data on the database and then completes settlement of each member store settlement amount.

The service provider server requests the bank server to transfer the service provider fees for each bank from the service provider account to the fee account (settlement completion fee).

In this case, the fee accounts are opened for each bank and managed separately.

According to an embodiment of the present invention, when a payment cancellation request occurs, approval is processed only when a cancellation amount is less than or equal to a planned deposit amount to the corresponding member store, and an amount obtained by deducting the canceled amount from the total of member store settlement amount is paid.

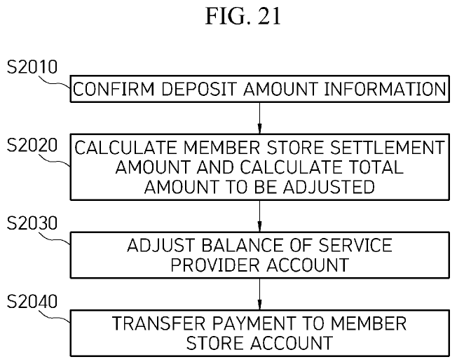

FIG. 21 is a flowchart illustrating a settlement method according to an embodiment of the present invention.

According to the present invention, a settlement method includes: confirming amount information deposited into a service provider account according to payment approval (S2010); calculating member store settlement amount using the amount information and transaction information matched thereto, and calculating a total amount to be adjusted for each service provider account (S2020); adjusting a balance between service provider accounts according to the total amount to be adjusted (S2030); and transferring payment to an affiliate store account (S2040).

In operation S2020, a database is constructed using the transaction information including customer information, member store information, approval amount, and fee information.

In operation S2030, a transfer is made from the service provider account with a surplus amount to the service provider account with an insufficient amount in consideration of the total amount to be adjusted, and a transfer from service provider accounts, which have a surplus amount in order of the largest absolute value of the total amount to be adjusted to service provider accounts, which have an insufficient amount in the order of the largest absolute value of the total amount to be adjusted is made according to a preset order, and a balance is sequentially adjusted in consideration of balance information after the transfer.

A transfer is made from the service provider account with a surplus amount to the service provider account with an insufficient amount in consideration of the total amount to be adjusted, and a transfer from service provider accounts, which have a surplus amount in order of the largest absolute value of the total amount to be adjusted to service provider accounts, which have an insufficient amount in the order of the largest absolute value of the total amount to be adjusted, is made according to a preset order, and a balance is sequentially adjusted in consideration of balance information after the transfer.

Alternatively, in operation S2030, it is possible to adjust the balance according to the preset method so that the total number of steps of the transfer process (balancing process) is minimized in consideration of the information on the service provider account with a surplus amount of the total amount to be adjusted and the service provider account with an insufficient amount of the total amount to be adjusted.

In operation S2040, according to the completion of the balance adjustment performed in operation S2030, a transfer is made from the service provider account provided for each bank to the member store account of the corresponding bank.

Meanwhile, the settlement method according to an embodiment of the present invention may be implemented in a computer system or recorded on a recording medium. The computer system may include at least one processor, a memory, a user input device, a data communication bus, a user output device, and storage. Each of the above-described components performs data communication through a data communication bus.

The computer system may further include a network interface coupled to the network. The processor may be a central processing unit (CPU) or a semiconductor device that processes instructions stored in a memory and/or storage.

The memory and storage may include various types of volatile or non-volatile storage media. For example, the memory may include a read only memory (ROM) and a random access memory (RAM).

Accordingly, the settlement method according to the embodiment of the present invention may be implemented as a computer-executable method. When the settlement method according to the embodiment of the present invention is performed in a computer device, computer-readable instructions may perform the settlement method according to the present invention.

Meanwhile, the settlement method according to the present invention described above may be implemented as a computer-readable code in a computer-readable recording medium. The computer-readable recording medium may include all kinds of recording media in which data that may be read by a computer system is stored. For example, there may be a ROM, a RAM, a magnetic tape, a magnetic disk, a flash memory, an optical data storage device, and the like. In addition, computer-readable recording media may be distributed in computer systems connected through a computer communication network and may be stored and executed as readable codes in a distributed manner.

Hereinabove, the embodiments of the present invention have been mainly described. It will be understood by those skilled in the art to which the present invention pertains that the present invention may be implemented in a modified form without departing from essential characteristics of the present invention. Therefore, embodiments disclosed herein should be considered in an illustrative aspect rather than a restrictive aspect. The scope of the present invention should be defined by the claims rather than the above-described description, and equivalents to the claims should be interpreted to fall within the present invention.

1. A settlement server comprising:
a receiver configured to receive deposit information and payment information to be sent to a service provider account according to payment approval;
a memory in which a program for performing member store payment settlement using the deposit information and the payment information is stored; and
a processor configured to execute the program,
wherein the processor performs balance adjustment between service provider accounts for each bank.

2. The settlement server of claim 1, wherein the processor generates settlement data using the payment information including customer information, member store information, approval amount, and fee information.

3. The settlement server of claim 2, wherein the processor uses the customer information that includes customer's account information used when making debit payment and customer's credit card company information used when making credit payment, and uses the member store information that includes member store unique information and member store account information.

4. The settlement server of claim 2, wherein the processor generates settlement data using the fee information that includes an affiliate store fee, a bank or a card company fee, and a service provider fee.

5. The settlement server of claim 2, wherein the processor calculates settlement data for each service provider account provided in each bank and calculates a total amount to be adjusted for each account.

6. The settlement server of claim 5, wherein the processor performs the balance adjustment by performing a transfer from a first service provider account with a surplus amount to a second service provider account with an insufficient amount in consideration of the total amount to be adjusted.

7. The settlement server of claim 6, wherein the processor makes a transfer from service provider accounts, which have the surplus amount in order of a largest absolute value of the total amount to be adjusted to service provider accounts, which have the insufficient amount in the order of the largest absolute value of the total amount to be adjusted, according to a preset order and sequentially performs the balance adjustment in consideration of balance information after the transfer.

8. The settlement server of claim 6, wherein the processor adjusts the balance in consideration of the number of steps of the transfer process in consideration of the information on the service provider account with the surplus amount of the total amount to be adjusted and the service provider account with the insufficient amount of the total amount to be adjusted.

9. The settlement server of claim 6, wherein, when the balance adjustment is completed, the processor requests an affiliate store settlement amount transfer and compares and verifies the balance of the service provider accounts for each bank and data on a database to perform a settlement completion process.

10. A settlement method comprising:
(a) confirming amount information deposited into a service provider account according to payment approval;
(b) calculating member store settlement amount using the amount information and transaction information matched thereto and calculating a total amount to be adjusted for each service provider account;
(c) adjusting a balance between service provider accounts according to the total amount to be adjusted; and
(d) transferring payment to an affiliate store account.

11. The settlement server of claim 10, wherein, in operation (b), a database is constructed using the transaction information including customer information, member store information, approval amount, and fee information.

12. The method of claim 10, wherein, in operation (c), the transfer is made from a service provider account with a surplus amount to a service provider account with an insufficient amount in consideration of the total amount to be adjusted.

13. The method of claim 12, wherein, in operation (c), a transfer from service provider accounts, which have the surplus amount in order of the largest absolute value of the total amount to be adjusted to service provider accounts, which have the insufficient amount in the order of the largest absolute value of the total amount to be adjusted, is made according to a preset order, and the balance is sequentially adjusted in consideration of balance information after the transfer.

14. The method of claim 12, wherein, in operation (c), the balance is adjusted in consideration of the number of steps of the transfer process in consideration of the information on the service provider account with the surplus amount of the total amount to be adjusted and the service provider account with the insufficient amount of the total amount to be adjusted.

15. The method of claim 10, wherein, in operation (d), the transfer is made from the service provider account provided for each bank to an affiliate store account of a corresponding bank according to adjustment completion of the balance.
